(19) United States
(12) Patent Application Publication
(10) Pub. No.: US 2025/0068296 A1
(43) Pub. Date: Feb. 27, 2025

(54) INFORMATION PROCESSING METHOD, INFORMATION PROCESSING DEVICE, AND NON-TRANSITORY COMPUTER READABLE RECORDING MEDIUM

(71) Applicant: Panasonic Intellectual Property Corporation of America, Torrance, CA (US)

(72) Inventors: Risako TANIGAWA, Kanagawa (JP); Kazuki KOZUKA, Osaka (JP)

(73) Assignee: Panasonic Intellectual Property Corporation of America, Torrance, CA (US)

(21) Appl. No.: 18/948,120

(22) Filed: Nov. 14, 2024

Related U.S. Application Data
(63) Continuation of application No. PCT/JP2023/018245, filed on May 16, 2023.
(60) Provisional application No. 63/342,785, filed on May 17, 2022.

(30) Foreign Application Priority Data
Mar. 30, 2023 (JP) 2023-056542

(51) Int. Cl. G06F 3/04817; G06F 3/0486; G06Q 50/08

(52) U.S. Cl. CPC G06F 3/04817; G06F 3/0486; G06Q 50/08

(57) ABSTRACT

An information processing device displays a bird's-eye view on a display of a terminal device, displays, in the bird's-eye view, a plurality of photography point icons indicating photography points and a selection icon for selecting an arbitrary position in the bird's-eye view, the selection icon being configured movably on the bird's-eye view, and the plurality of photography point icons being associated with image information indicating an image photographed at a photography point, detects a movement completion position of the selection icon, and decides one photography point icon based on the movement completion position and a position of each photography point icon, and outputs, to the display, image information associated with the one photography point icon.

### FIELD OF INVENTION

The present disclosure relates to a technique for selecting an image.

### BACKGROUND ART

Patent Literature 1 discloses displaying an image (e.g., a contour line) indicating a designated area designated by a worker on a bird's-eye photographed image of a work site, and displaying chatting related to the designated area input by the worker into a display field provided next to the bird's-eye photographed image.

However, in the conventional technique disclosed in Patent Literature 1, the bird's-eye photographed image is not associated with image information photographed at each of a plurality of photography points in the work site, and thus there is a problem that the state of the work site cannot be remotely checked in detail.
Patent Literature 1: JP 2021-86224 A

### SUMMARY OF THE INVENTION

An object of the present disclosure is to provide a technique that can remotely check in detail a state of a site indicated by a bird's-eye view.

An information processing method in one aspect of the present disclosure is an information processing method in a computer, the method including: displaying a bird's-eye view on a display of a terminal device; displaying, in the bird's-eye view, a plurality of photography point icons indicating photography points and a selection icon for selecting an arbitrary position in the bird's-eye view, the selection icon being configured movably on the bird's-eye view, and the plurality of photography point icons being associated with image information indicating an image photographed at a photography point; detecting a movement completion position of the selection icon, and deciding one photography point icon based on the movement completion position and a position of each photography point icon; and outputting, to the display, image information associated with the one photography point icon.

According to this configuration, the state of the site indicated by the bird's-eye view can be remotely checked in detail.

### BRIEF DESCRIPTION OF THE DRAWINGS

FIG. 1 is a block diagram illustrating an example of a configuration of an information processing system according to an embodiment of the present disclosure.

FIG. 2 is a view illustrating an example of a display screen displayed on a display of a terminal device.

FIG. 3 is an enlarged view displaying an image information display field and an annotation information display field illustrated in FIG. 2.

FIG. 4 is a view illustrating a design drawing display field when a selection icon is moved.

FIG. 5 is a flowchart showing an example of processing of an information processing device illustrated in FIG. 1.

FIG. 6 is a flowchart showing details of display processing shown in FIG. 5.

### DETAILED DESCRIPTION

(How One Aspect of the Present Disclosure has Come about)

Problems at a construction site include problems on communication such as failing to get a specific instruction through to a worker and explanation of the instruction being time taking, and problems on checking of the construction site such as necessity of manpower to go around the entire construction site and movement to the construction site being time taking.

In order to solve such problems, for example, it is conceivable that a large number of cameras are installed at a construction site, and a site supervisor who is remote gives an instruction to a worker while referring to images obtained from the large number of cameras. However, in the construction site, as construction progresses, work such as removing an installed sensor or installing the removed sensor in another place occurs. Since this kind of work takes time and effort, it is not practical installing a sensor at a construction site. Therefore, the present inventor has studied a technique that can remotely check in detail the situation of the construction site without installing a sensor.

Then, it has been found that the situation of a construction site can be remotely checked in detail if there is a user interface that, in response to an input of an operation of selecting a position in a design drawing of the construction site displayed on a display, displays an image of the construction site photographed in advance at the position and an annotation input by a worker for the image.

The present disclosure has been made based on such findings.

(1) An information processing method in one aspect of the present disclosure is an information processing method in a computer, the method including: displaying a bird's-eye view on a display of a terminal device; displaying, in the bird's-eye view, a plurality of photography point icons indicating photography points and a selection icon for selecting an arbitrary position in the bird's-eye view, the selection icon being configured movably on the bird's-eye view, and the plurality of photography point icons being associated with image information indicating an image photographed at a photography point; detecting a movement completion position of the selection icon, and deciding one photography point icon based on the movement completion position and a position of each photography point icon; and outputting, to the display, image information associated with the one photography point icon.

A plurality of photography point icons and a selection icon are displayed on a bird's-eye view. When a movement completion position of the selection icon on the bird's-eye view is detected, one photography point icon is decided based on the movement completion position and the position of each photography point icon. Image information associated with the decided one photography point icon is displayed. This image information indicates an image photographed at a photography point. This enables the user to remotely check the situation of the site at the photography point. Therefore, the user who has viewed the image information can remotely check in detail the situation of the site indicated by the bird's-eye view. Since image information can be displayed by such a simple operation, the number of processing steps of the computer spent for the operation can be reduced.

(2) In the information processing method according to (1), the plurality of photography point icons may include a first photography point icon associated with annotation information, in the decision, when the movement completion position is positioned outside a predetermined region from a position of each of the plurality of photography point icons, a first photography point icon closest to the movement completion position may be decided as the one photography point icon, and in the output, image information and annotation information associated with a selected first photography point icon may be output to the display.

According to this configuration, the user can select the first photography point icon by moving the selection icon close to the first photography point icon even without moving the selection icon within a predetermined range of the first photography point icon. Therefore, the user can select the first photography point icon without performing a detailed operation such as moving the selection icon from the first photography point icon to within the predetermined range. As a result, the user can easily view annotation information and image information related to the annotation information with a simple operation. Note that, in a case where a plurality of users share a bird's-eye view, it is considered that there are many cases where each user desires to preferentially view annotation information added to a photography point by another user. Therefore, the present configuration is useful for such needs.

(3) In the information processing method according to (1) or (2), in the decision, when the movement completion position is positioned within a predetermined region from a position of any photography point icon, the photography point icon may be decided as the one photography point icon.

According to this configuration, by moving the selection icon from the position of any photography point icon into the predetermined region, the user can view image information associated with the photography point icon.

(4) The information processing method according to any one of (1) to (3) may further include: detecting a current position of the selection icon in motion, deciding a predetermined number of photography point icons in order of proximity from the current position, and highlighting the predetermined number of photography point icons.

According to this configuration, when the selection icon is in motion, the predetermined number of photography point icons are highlighted in order of proximity from the current position of the selection icon. Therefore, it is possible to cause the user to recognize the photography point icon close to the selection icon.

(5) In the information processing method according to any one of (1) to (4), the highlighting may include enlarging and displaying each of the predetermined number of photography point icons to a size indicating a predetermined region.

According to this configuration, when the selection icon is brought close to the photography point icon, a selection icon is enlarged and displayed to a size indicating the predetermined region, and therefore it is possible to cause the user to recognize the size of the predetermined region, and the user can easily select the photography point icon.

(6) In the information processing method according to (4), the plurality of photography point icons may include a first photography point icon associated with annotation information, and the first photography point icon may be displayed in association with an annotation icon, and the highlighting may include enlarging and displaying an annotation icon associated with the first photography point icon when the predetermined number of photography point icons include the first photography point icon.

According to this configuration, when the selection icon is brought close to the first photography point icon associated with the annotation information, the annotation icon is enlarged and displayed, and therefore it is possible to cause the user to more reliably recognize that the photography point icon near the selection icon is the photography point icon associated with the annotation information.

(7) In the information processing method according to any one of (1) to (6), the bird's-eye view may be a design drawing, and the image information may indicate an image photographed by an omnidirectional camera at a construction site expressed by the design drawing.

According to this configuration, when the user selects a certain photography point icon displayed on the design drawing, image information associated with the photography point icon is displayed, and moreover this image information indicates an image photographed by the omnidirectional camera. Therefore, the user can check the situation of the site in more detail with reference to the design drawing.

(8) In the information processing method according to any one of (1) to (7), movement of the selection icon may be dragging, and the movement completion position may be a dropping position of the selection icon.

According to this configuration, the user can select the photography point icon by performing a drag and drop operation on the selection icon.

(9) In the information processing method according to any one of (1) to (8), an object region indicating an object included in an image indicated by the image information may be set in the image information, and the annotation information may indicate an annotation related to the object.

According to this configuration, it is possible to cause the user to check the annotation related to the object included in the image indicated by the image information.

(10) An information processing device in another aspect of the present disclosure is an information processing device including a processor, in which the processor executes processing of: displaying a bird's-eye view on a display of a terminal device; displaying, in the bird's-eye view, a plurality of photography point icons indicating photography points and a selection icon for selecting an arbitrary position in the bird's-eye view, the selection icon being configured movably on the bird's-eye view, and the plurality of photography point icons being associated with image information photographed at a photography point; detecting a movement completion position of the selection icon, and deciding one photography point icon based on the movement completion position and a position of each photography point icon; and outputting, to the display, image information associated with the one photography point icon.

According to this configuration, it is possible to provide an information processing device that can remotely check in detail the situation of the site indicated by the bird's-eye view.

(11) An information processing program in another aspect of the present disclosure causes a computer to execute the information processing method according to any one of (1) to (9).

According to this configuration, it is possible to provide an information processing program that can remotely check in detail the situation of the site indicated by the bird's-eye view.

The present disclosure can also be implemented as an information processing system that operates by such an information processing program. It is needless to say that such a computer program can be distributed via a computer-readable non-transitory recording medium such as a CD-ROM, or via a communication network such as the Internet.

Each of embodiments described below illustrates a specific example of the present disclosure. Numerical values, shapes, components, steps, order of steps, and the like shown in the embodiments below are merely one example, and are not intended to limit the present disclosure. A component that is not described in an independent claim representing the highest concept among components in the embodiments below is described as an arbitrary component.

In all the embodiments, respective contents can be combined.

### Embodiment

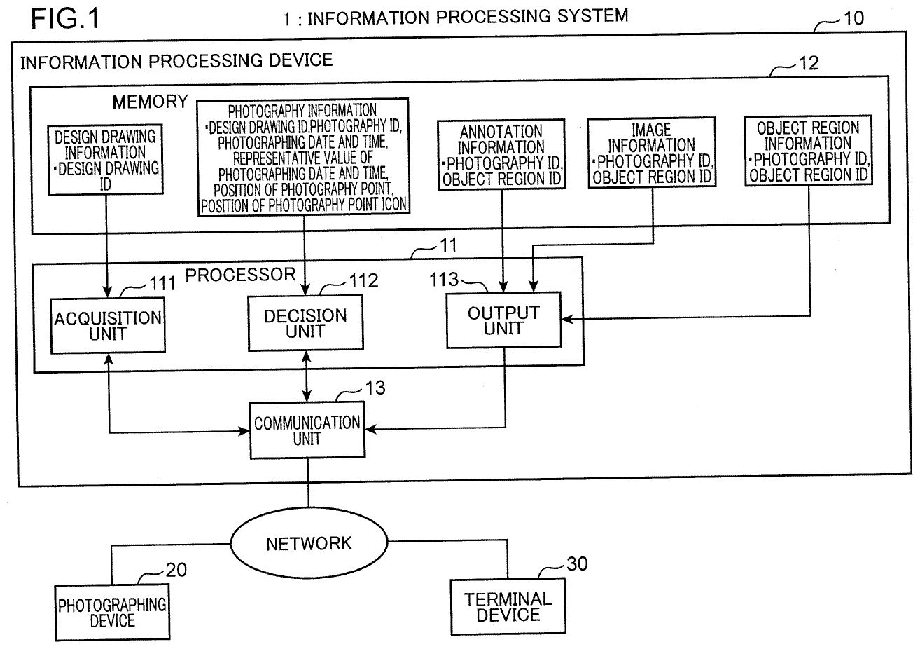

FIG. 1 is a block diagram illustrating an example of the configuration of an information processing system 1 in an embodiment of the present disclosure. The information processing system 1 includes an information processing device 10, a photographing device 20, and a terminal device 30. The information processing device 10, the photographing device 20, and the terminal device 30 are communicably connected via a network. An example of the network is the Internet. The information processing device 10 is, for example, a cloud server including one or a plurality of computers. However, this is an example, and the information processing device 10 may be configured by an edge server or may be implemented in the terminal device 30.

The photographing device 20 includes, for example, an omnidirectional camera, and photographs an image at a predetermined frame rate. The photographing device 20 is, for example, a portable photographing device possessed by the user. The user is, for example, a worker and a site supervisor at a construction site. The user moves in the construction site while photographing the construction site with the photographing device 20. The photographing device 20 transmits image information indicating a photographed image to the information processing device 10 via the network. In the image information, the position of photography point indicating the photography point is associated with the photographing date and time. The position of photography point is acquired by, for example, a position sensor such as a magnetic sensor or a GPS sensor included in the photographing device 20, and is represented by latitude and longitude. The photographing date and time is acquired by, for example, a clock included in the photographing device 20. This enables the information processing device 10 to obtain image information at a plurality of photography points in the construction site. Here, since the photographing device 20 photographs an image at a predetermined frame rate, the photography point is defined in units of frame periods. However, this is an example, and the photography point may be defined every predetermined time (e.g., 1 second, 1 minute, and the like). The photographing device 20 includes an image sensor, an operation device, a communication circuit, and a signal processing circuit. The photographing device 20 may be configured by a portable computer such as a smartphone or a tablet computer.

The terminal device 30 is possessed by the user. The terminal device 30 may be configured by, for example, a portable computer such as a smartphone or a tablet computer, or may be configured by a stationary computer. The terminal device 30 displays screen information on the display under the control of the information processing device 10. Although one terminal device 30 is illustrated in the example of FIG. 1, a plurality of terminal devices may be connected to the information processing device 10 via a network. The terminal device 30 includes a central processing unit (CPU), a memory, a display, an operation device such as a touchscreen and a keyboard, and a communication circuit.

The information processing device 10 includes a processor 11, a memory 12, and a communication unit 13. The processor 11 includes, for example, a central processing unit (CPU). The processor 11 includes an acquisition unit 111, a decision unit 112, and an output unit 113. The acquisition unit 111 to the output unit 113 may be implemented by the processor 11 executing an information processing program, or may be configured by a dedicated hardware circuit such as an ASIC.

The acquisition unit 111 acquires, from the terminal device 30, an instruction to select a design drawing from the user, reads, from the memory 12, design drawing information indicated by the instruction, and displays the read design drawing information on the display of the terminal device 30. The design drawing information is information indicating the design drawing of the construction site. The design drawing information is an example of bird's-eye view. The acquisition unit 111 displays, on the terminal device 30, a plurality of photography point icons indicating photography points in the design drawing and a selection icon for selecting an arbitrary position in the design drawing. These displays are implemented by the acquisition unit 111 transmitting a display instruction to the terminal device 30 using the communication unit 13. The selection icon is configured movably on the design drawing. The acquisition unit 111 displays a photography point icon at a position on the design drawing corresponding to the photography point. In the design drawing, latitude and longitude are associated in advance with a position to be a key point. The position to be a key point is, for example, the position of four corners of the design drawing.

The decision unit 112 acquires, from the terminal device 30, a current position of the selection icon moved on the design drawing by a user's operation. This current position is a coordinate on the design drawing.

The decision unit 112 detects a movement completion position of the selection icon. The selection icon is configured movably by a drag and drop operation. Hereinafter, the movement completion position is referred to as a dropping position. The decision unit 112 may detect, as the dropping position, the current position of the selection icon when operation information indicating a drop operation is acquired from the terminal device 30 via the communication unit 13.

The decision unit 112 decides one photography point icon based on the detected dropping position and the position of each photography point icon.

The plurality of photography point icons include a first photography point icon associated with image information and annotation information. The annotation information indicates an annotation input using the terminal device 30 by the user who has viewed the image information. Using the terminal device 30, the user inputs an object region indicating an object included in the image indicated by the image information. The annotation is given to this object. For example, the annotation is a message indicating content to be noted in work for this object. An annotation icon indicating that there is an annotation is displayed in association with the first photography point icon.

When the dropping position is positioned outside a predetermined region from the position of each of the plurality of photography point icons, the decision unit 112 decides, as one photography point icon, the first photography point icon closest to the dropping position.

When the dropping position is positioned within the predetermined region from the position of a certain photography point icon, the decision unit 112 decides the photography point icon as one selection icon.

The decision unit 112 decides a predetermined number of photography point icons in order of proximity from the current position of the selection icon acquired from the terminal device 30 via the communication unit 13, and highlights the predetermined number of photography point icons. As the predetermined number, for example, an appropriate value such as one, two, or three can be adopted.

The highlighting includes enlarging and displaying each of the predetermined number of photography point icons to a size indicating a predetermined region. The highlighting includes enlarging and displaying an annotation icon associated with the first photography point icon when the predetermined number of photography point icons include the first photography point.

The output unit 113 reads, from the memory 12, image information associated with the one photography point icon decided by the decision unit 112, and displays the read image information on the display of the terminal device 30. If the one selection icon is the first photography point icon, the output unit 113 may read, from the memory 12, image information and annotation information associated with the one photography point icon, and display the obtained image information and annotation information on the display of the terminal device 30. On the other hand, if the one selection icon is not the first photography point icon, the output unit 113 may read, from the memory 12, image information associated with the one photography point icon, and display the obtained image information on the display of the terminal device 30. Here, the output unit 113 may display the image information and the annotation information on the display of the terminal device 30 by transmitting the image information and the annotation information read from the memory 12 to the terminal device 30 using the communication unit 13.

The memory 12 includes a nonvolatile rewritable storage device such as a hard disk drive or a solid state drive. The memory 12 stores design drawing information, photography information, annotation information, and image information. The design drawing information is image information indicating a design drawing. The design drawing information is associated with a design drawing ID for identifying the design drawing. In the design drawing, latitude and longitude of an actual construction site are set as a key point as described above.

The photography information indicates information regarding one photographing operation using the photographing device 20. The photography information is generated every time one photographing operation is performed. One photographing operation refers to a series of operations from the start of photographing to the end of photographing at the construction site by a worker with the photographing device 20. A plurality of images are photographed by one photographing operation. The photography information includes a design drawing ID, a photography ID, a photographing date and time, a representative value of photographing date and time, a position of photography point, and a position of photography point icon. The design drawing ID is an identifier of a design drawing of the construction site that is photographed. The photography ID is an identifier for identifying each photography included in one photographing operation. The photographing date and time is photographing date and time of the photography indicated by the photography ID. The representative value of photographing date and time is photographing date and time when photography is started. The photography point indicates a position (latitude and longitude) at which photography indicated by the photography ID is performed. The position of photography point icon indicates a display position (coordinates) on the design drawing of the photography point icon corresponding to the photography ID. The position of photography point icon is calculated by mapping the photography position onto the design drawing based on the photography position (latitude and longitude) at the key point of the design drawing indicated by the design drawing information and the photography point (latitude and longitude) corresponding to the photography ID.

The annotation information is information indicating an annotation. One piece of annotation information corresponds to one annotation. The annotation information is associated with a photography ID and an object region ID. The object region ID is an identifier of an object region set in the image information corresponding to the photography ID, the object region given an annotation.

The image information indicates one image photographed by each photography included in one image photographing operation. The image information is associated with a photography ID and an object region ID. When a plurality of object regions are set in the image information corresponding to the photography ID, the image information includes a plurality of object region IDs.

The object region information stores the position (coordinates) of the key point of the object region set in the image information corresponding to the photography ID. The key point is a vertex on the contour of the object region. The object region information is associated with a photography ID and an object region ID.

In this manner, since the photography information and the image information are associated with the photography ID, the image information corresponding to the photography point icon is specified using the photography ID as a key. Since the annotation information and the object region information are associated with the object region ID, the annotation information corresponding to the object region information is specified using the object region ID as a key. Since the object region information and the image information are associated with the photography ID, the image information corresponding to the object region information is specified using the photography ID as a key. The photography point icon corresponding to the photography ID associated with the annotation information is the first photography point icon.

The communication unit 13 is a communication circuit that connects the information processing device 10 to a network.

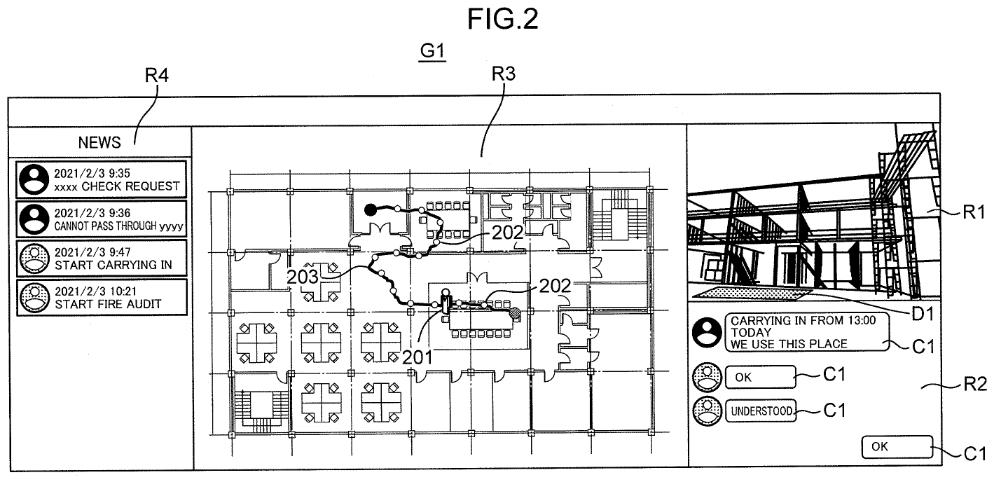

FIG. 2 is a view illustrating an example of a display screen G1 displayed on the display of the terminal device 30. The display screen G1 is a basic screen of an application provided by the information processing device 10. The display screen G1 includes an image information display field R1, an annotation information display field R2, a design drawing display field R3, and a news display field R4.

The image information display field R1 displays image information associated with the one photography point icon decided by the decision unit 112.

The annotation information display field R2 displays annotation information associated with the decided one photography point icon. Here, annotations C1 input by a plurality of users for the image information displayed in the image information display field R1 are displayed in a list form. In the annotation information display field R2, an annotation C1 input by a user other than the user himself/herself is displayed on the left side, and an annotation C1 input by the user himself/herself is displayed on the right side.

In the default display screen G1 immediately after the start of the application, the photography point icon is not selected by the user. Therefore, in the default display screen G1, the image information display field R1 and the annotation information display field R2 are blank.

The design drawing display field R3 displays a design drawing of the construction site. In the design drawing displayed in the design drawing display field R3, a selection icon 201, a photography point icon 202, and a trajectory 203 are displayed in a superimposed manner.

The selection icon 201 is configured movably by a drag and drop operation. In this example, the selection icon 201 includes an image simulating a human.

The photography point icon 202 is an icon indicating a photography point, and is associated with image information. In this example, the photography point icon 202 includes a circular image. The trajectory 203 indicates a trajectory of the user who has photographed the image information. In this example, the trajectory 203 includes a line connecting the adjacent photography point icons 202. The photography point icon 202 positioned at the leading end of the trajectory 203 and the photography point icon 202 positioned at the trailing end of the trajectory 203 are displayed in a larger size than that of the other photography point icons. The photography point icon 202 positioned at the leading end (e.g., the right end) of the trajectory 203 indicates a photography start position, and the photography point icon 202 positioned at the trailing end (e.g., the left end) of the trajectory 203 indicates a photography end position.

The news display field R4 displays various messages related to this construction site, the messages input by the user.

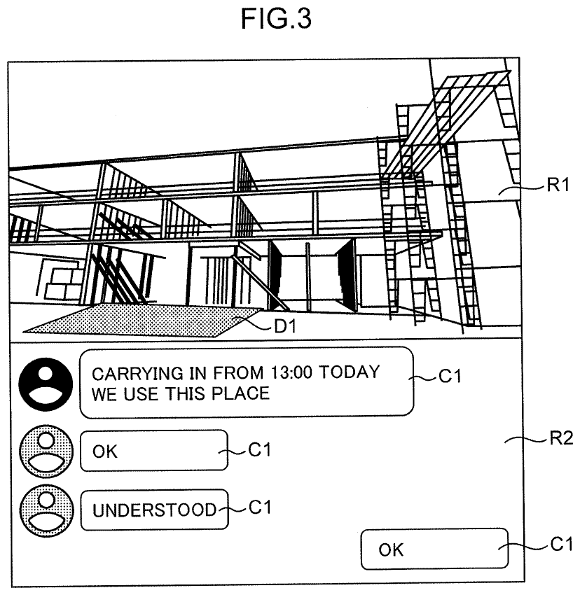

FIG. 3 is an enlarged view displaying the image information display field R1 and the annotation information display field R2 illustrated in FIG. 2. An object region D1 is set in the image information. The object region D1 indicates a region of an object to be noted input by the user for the image information displayed in the image information display field R1. When the user inputs, using the terminal device 30, a selection instruction for the object region D1 in the image information display field R1, the terminal device 30 displays a frame body (not illustrated) for selecting the object region D1 in the image information display field R1. The frame body is, for example, a quadrangle. The user operates the terminal device 30 to move and deform this frame body to superimpose the frame body on a certain object displayed in the image information display field R1. Due to this, the object region D1 is set.

In the example of FIG. 3, the object region D1 is set on the ground in front of the building under construction. The object region information indicating the object region D1 having been set is stored in the memory 12 in association with the object region ID and the image ID. The object region information includes coordinates indicating the key point of the object region D1. The key point is, for example, a vertex of the object region D1. The annotation C1 is an annotation input by the user to the object region D1. The annotation information indicating the annotation C1 is stored in the memory 12 in association with the object region ID of the object region D1. Due to this, the object region D1 set in the image information and the annotation information indicating the annotation C1 input to the object region D1 are managed in association with each other.

In the example of FIG. 3, there is one object region D1, but the user can set a plurality of object regions. In this case, the user may perform the operation of moving and deforming the frame body a plurality of times. The object region ID is individually assigned to the object region information indicating the plurality of respective object regions and stored in the memory 12.

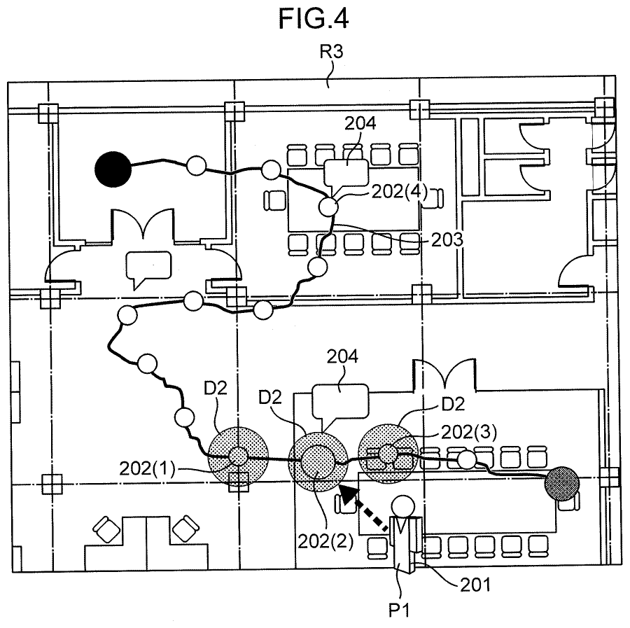

FIG. 4 is a view illustrating the design drawing display field R3 when the selection icon 201 is moved. The selection icon 201 is dragged in a direction indicated by an arrow. During dragging of the selection icon 201, the decision unit 112 calculates the respective distances between the position (coordinates) of the selection icon 201 and the positions (coordinates) of the plurality of photography point icons 202 present on the trajectory 203. In this case, the photography point icons 202 of the top three (an example of the predetermined number) in ascending order of distance are the photography point icons 202(1), 202(2), and 202(3). Therefore, the photography point icons 202(1), 202(2), and 202(3) are enlarged and displayed to a size indicating a predetermined region D2. This can cause the user to recognize the photography point icon 202 close to the selection icon 201 and to cause the user to recognize the size of the predetermined region D2.

The photography point icon 202(2) is the photography point icon 202 associated with an annotation icon 204, that is, the first photography point icon. Therefore, this annotation icon 204 is also enlarged and displayed. The annotation icon 204 is an icon indicating that there is an annotation, and a balloon mark is adopted in the example of FIG. 4. On the other hand, the photography point icon 202(4) is also the photography point icon 202 associated with the annotation icon 204, that is, the first photography point icon. Since the distance between the photography point icon 202(4) and the selection icon 201 is not in the top three places, the annotation icon 204 is not enlarged and displayed.

For example, it is assumed that the selection icon 201 is dropped at a dropping position P1 illustrated in FIG. 4. The dropping position P1 is positioned outside the predetermined region D2 with respect to any of the photography point icons 202. Therefore, from among the photography point icons 202(2) and 202(4) associated with the annotation icon 204, the photography point icon 202(2) having the shortest distance to the dropping position P1 is decided as the one photography point icon 202. Due to this, the user can select the first photography point icon without performing a detailed operation such as moving the selection icon 201 from the first photography point icon to within the predetermined region D2. As a result, the user can easily view annotation information and image information related to the annotation information with a simple operation.

For example, it is assumed that the selection icon 201 is dropped in the predetermined region D2 of the photography point icon 202(1). In this case, the photography point icon 202(1) is decided as the one photography point icon. In this manner, when the selection icon 201 is dropped in the predetermined region D2, regardless of whether or not the annotation icon 204 is associated, the photography point icon 202 corresponding to the predetermined region D2 where the selection icon 201 is dropped is decided as the one photography point icon. Due to this, the user can view the image information associated with the photography point icon by moving the selection icon 201 from the position of photography point icon into the predetermined region D2.

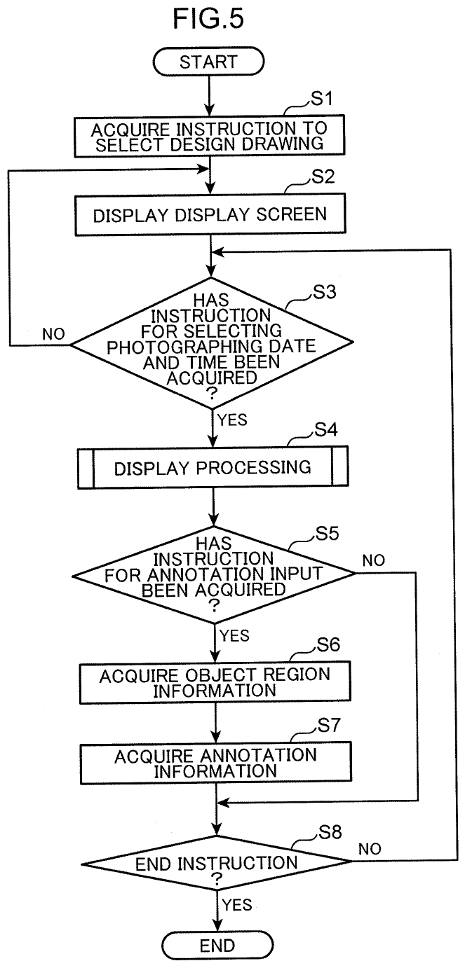

FIG. 5 is a flowchart showing an example of the processing of the information processing device 10 illustrated in FIG. 1. The acquisition unit 111 acquires an instruction from a user who selects a design drawing (step S1). In this case, a menu screen for selecting a design drawing is displayed on the display of the terminal device 30, and an instruction to select one design drawing from the menu screen is input. The instruction that is input is transmitted to the information processing device 10 via the network and received by the communication unit 13. The acquisition unit 111 acquires the instruction via the communication unit 13. Since this instruction includes the design drawing ID, the acquisition unit 111 can acquire design drawing information indicating the instructed design drawing from among the design drawing information stored in the memory 12.

Next, the acquisition unit 111 displays the display screen G1 on the display of the terminal device 30 by transmitting a display instruction of the display screen G1 to the terminal device 30 via the communication unit 13 (step S2). The display instruction on the display screen G1 displayed by default includes the design drawing information indicating the design drawing selected in step S1 and the photography information corresponding to the latest photographing date and time. Therefore, as illustrated in FIG. 2, the display screen G1 displayed by default includes the selection icon 201 in the design drawing view, and the photography point icon 202 and the trajectory 203 corresponding to the latest photographing date and time. At this time point, since one photography point icon has not been decided, the image information display field R1 and the annotation information display field R2 are blank. Note that, when an instruction to select the photographing date and time is input in step S3 described later, the acquisition unit 111 displays, on the display, the display screen G1 including the design drawing on which the photography point icon 202 and the trajectory 203 corresponding to the selected photographing date and time are superimposed and displayed.

Next, the acquisition unit 111 determines whether or not to have acquired an instruction from the user for selecting the photographing date and time (step S3). In this case, the display of the terminal device 30 displays a menu screen for selecting photographing date and time. The user inputs an instruction to select one photographing date and time from the menu screen. The photographing date and time displayed on the menu screen is a representative value of the photographing date and time included in the photography information stored in the memory 12. When the photographing date and time is selected, one photographing operation corresponding to the photographing date and time is selected. The instruction that is input is transmitted to the information processing device 10 via the network and received by the communication unit 13. The acquisition unit 11I acquires the instruction via the communication unit 13. Since this instruction includes the representative value of the photographing date and time, the acquisition unit 11I can specify one piece of photography information stored in the memory 12. When the instruction to select the photographing date and time is input (YES in step S3), the processing proceeds to step S4. When the instruction to select the photographing date and time is not input (NO in step S3), the processing returns to step S2.

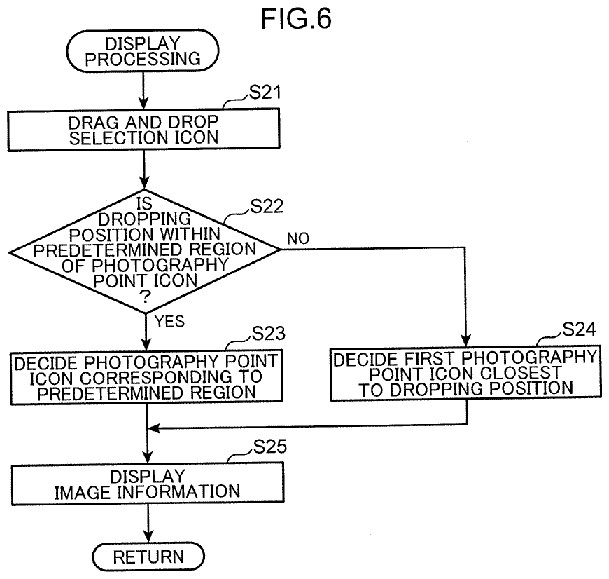

Next, display processing is executed (step S4). Details of the display processing will be described later with reference to FIG. 6. The display processing is processing of deciding one photography point icon by dragging and dropping the selection icon 201 on the design drawing and displaying image information associated with the decided one photography point icon in the image information display field R1.

Next, the acquisition unit 111 determines whether or not to have acquired an instruction for annotation input (step S5). The instruction for annotation input is an instruction input when the user intends to input an annotation to the image information displayed in the image information display field R1. This instruction is input by performing an operation of selecting the instruction for annotation input button (not illustrated) displayed on the display screen G1, for example. The instruction that is input is transmitted to the information processing device 10 via the network and received by the communication unit 13. The acquisition unit 111 acquires the instruction via the communication unit 13.

Next, when the instruction for annotation input has been acquired (YES in step S5), the acquisition unit 111 acquires object region information (step S6). The object region information is input by performing an operation of moving and deforming the frame body (not illustrated) as described above in the image information display field R1. The object region information that is input is transmitted to the information processing device 10 via the network and received by the communication unit 13. The acquisition unit 111 acquires the object region information via the communication unit 13. The acquisition unit 111 assigns the object region ID to the acquired object region information, and stores, in the memory 12, the object region information in association with the photography ID. Due to this, the object region D1 is set as illustrated in FIG. 3.

Next, when the instruction for annotation input has not been acquired (NO in step S5), the processing proceeds to step S8.

Next, the acquisition unit 111 acquires annotation information (step S7). As illustrated in FIG. 3, the annotation information is input by inputting the annotation C1 in the annotation information display field R2 and pressing a transmission button not illustrated. The annotation information that is input is transmitted to the information processing device 10 via the network and received by the communication unit 13. The acquisition unit 111 acquires the annotation information via the communication unit 13. The acquisition unit 111 stores, in the memory 12, the acquired annotation information in association with the photography ID and the object region ID.

Next, the acquisition unit 111 determines whether or not to have acquired an end instruction (step S8). The end instruction is an instruction to close the display screen G1 displayed in step S3. This instruction is input by performing an operation of pressing an end button (not illustrated) displayed on the display screen G1. When the end instruction is acquired (YES in step S8), the processing ends. When the end instruction is not acquired (NO in step S8), the processing returns to step S3. In this case, the display of the display screen G1 is maintained. The end instruction is transmitted to the information processing device 10 via the network and received by the communication unit 13. The acquisition unit 111 acquires the end instruction via the communication unit 13.

FIG. 6 is a flowchart showing details of the display processing shown in FIG. 5. The acquisition unit 111 acquires an operation of dragging and dropping the selection icon 201 (step S21). This operation is performed by inputting an operation of dragging and dropping the selection icon 201 superimposed on the design drawing as illustrated in FIG. 4. Operation information indicating this operation is periodically transmitted from the terminal device 30 to the information processing device 10. This operation information includes the current position of the selection icon 201. Therefore, the decision unit 112 can acquire the current position of the selection icon 201 via the communication unit 13 and calculate the distance between the selection icon 201 and each photography point icon 202. Then, the decision unit 112 specifies a predetermined number (top three) of photography point icons 202 in ascending order of distance from the selection icon 201, and transmits, to the terminal device 30 via the communication unit 13, a display instruction to enlarge and display the specified photography point icons 202. When the operation information in which the selection icon 201 has been dropped is transmitted from the terminal device 30, the decision unit 112 detects, as the dropping position, the current position of the selection icon 201 at that time point.

Next, the decision unit 112 determines whether or not the dropping position is within the predetermined region D2 of the photography point icon 202 (step S22).

Next, when the dropping position is within the predetermined region D2 of the photography point icon 202 (YES in step S22), the decision unit 112 decides the photography point icon corresponding to the predetermined region D2 as one photography point icon (step S23). In the example of FIG. 4, if the dropping position is within the predetermined region D2 of the photography point icon 202(1), the photography point icon 202(1) is decided as the one photography point icon.

Next, when the dropping position is positioned outside the predetermined region D2 for any photography point icon 202 (NO in step S22), the decision unit 112 decides the first photography point icon closest to the dropping position as the one photography point icon (step S24). In the example of FIG. 4, when the selection icon 201 is dropped at the dropping position P1, the photography point icon 202(2) is decided as the one photography point icon.

Next, the output unit 113 displays the image information on the display screen G1 by transmitting, to the terminal device 30 via the communication unit 13, the image information corresponding to the one photography point icon decided in step S23 or S24. Due to this, the image information display field R1 displays an image indicating image information corresponding to the one photography point icon. Note that, in a case where the one photography point icon is the first photography point icon, the annotation information, in addition to the image information, is transmitted to the terminal device 30 via the communication unit 13. Due to this, the annotation information display field R2 displays the annotation C1 indicated by the annotation information corresponding to the image information displayed in the image information display field R1. On the other hand, when the one photography point icon is not the first photography point icon, the annotation information is not transmitted, and thus the annotation information display field R2 is blank.

In this manner, according to the above embodiment, one photography point icon is decided based on the dropping position of the selection icon 201 and the position of each photography point icon 202. Image information corresponding to the decided one photography point icon is displayed. This image information indicates an image photographed at a photography point. This enables the user to remotely check the situation of the construction site at the photography point. Therefore, the user who has viewed the image information can remotely check in detail the situation of the construction site indicated by the design drawing.

The present disclosure can adopt the following modifications.

(1) The bird's-eye view may be a room layout illustrating a room layout in a house. In this case, the present disclosure can be applied to renovation of interior of a house. The bird's-eye view may be a layout diagram simply illustrating a room layout in the house.

(2) In a case where annotation information is associated with the object region D1 but the object region D1 is not set, the annotation information may be associated with the image information.

(3) In the above embodiment, one photography point icon is decided by dragging and dropping the selection icon 201, but this is an example, and one photography point icon may be decided by an operation of positioning and clicking a mouse pointer at a desired position. For example, if the click position of the mouse pointer is within the predetermined region D2 with respect to any photography point icon 202, the photography point icon 202 corresponding to the clicked predetermined region D2 is decided as the one photography point icon. For example, when the click position of the mouse pointer is outside the predetermined region D2 for any photography point icon 202, the photography point icon 202 closest to the click position is decided as the one photography point icon.

(4) In the above embodiment, the construction site is exemplified as a site, but the present disclosure is not limited to this, and a manufacturing site, a distribution site, a logistics site, an agricultural land, a civil engineering site, a retail site, an office, a hospital, a commercial facility, a nursing care facility, or the like may be employed as the site.

The present disclosure is useful in managing a construction site because the situation of the construction site can be checked remotely.

1. An information processing method in a computer, the method comprising:
displaying a bird's-eye view on a display of a terminal device;
displaying, in the bird's-eye view, a plurality of photography point icons indicating photography points and a selection icon for selecting an arbitrary position in the bird's-eye view,
the selection icon being configured movably on the bird's-eye view, and
the plurality of photography point icons being associated with image information indicating an image photographed at a photography point;
detecting a movement completion position of the selection icon, and deciding one photography point icon based on the movement completion position and a position of each photography point icon; and
outputting, to the display, image information associated with the one photography point icon.

2. The information processing method according to claim 1, wherein
the plurality of photography point icons include a first photography point icon associated with annotation information,
in the decision, when the movement completion position is positioned outside a predetermined region from a position of each of the plurality of photography point icons, a first photography point icon closest to the movement completion position is decided as the one photography point icon, and
in the output, image information and annotation information associated with a selected first photography point icon are output to the display.

3. The information processing method according to claim 1, wherein in the decision, when the movement completion position is positioned within a predetermined region from a position of any photography point icon, the photography point icon is decided as the one photography point icon.

4. The information processing method according to claim 1, further comprising detecting a current position of the selection icon in motion, deciding a predetermined number of photography point icons in order of proximity from the current position, and highlighting the predetermined number of photography point icons.

5. The information processing method according to claim 4, wherein the highlighting includes enlarging and displaying each of the predetermined number of photography point icons to a size indicating a predetermined region.

6. The information processing method according to claim 4, wherein
the plurality of photography point icons include a first photography point icon associated with annotation information, and the first photography point icon is displayed in association with an annotation icon, and
the highlighting includes enlarging and displaying an annotation icon associated with the first photography point icon when the predetermined number of photography point icons include the first photography point icon.

7. The information processing method according to claim 1, wherein
the bird's-eye view is a design drawing, and
the image information indicates an image photographed by an omnidirectional camera at a construction site expressed by the design drawing.

8. The information processing method according to claim 1, wherein
movement of the selection icon is dragging, and
the movement completion position is a dropping position of the selection icon.

9. The information processing method according to claim 2, wherein
an object region indicating an object included in an image indicated by the image information is set in the image information, and
the annotation information indicates an annotation related to the object.

10. An information processing device comprising a processor,
wherein the processor executes processing of:
displaying a bird's-eye view on a display of a terminal device;
displaying, in the bird's-eye view, a plurality of photography point icons indicating photography points and a selection icon for selecting an arbitrary position in the bird's-eye view,
the selection icon being configured movably on the bird's-eye view, and
the plurality of photography point icons being associated with image information photographed at a photography point;
detecting a movement completion position of the selection icon, and deciding one photography point icon based on the movement completion position and a position of each photography point icon; and
outputting, to the display, image information associated with the one photography point icon.

11. A non-transitory computer readable recording medium storing an information processing program for causing a computer to execute a process of:
displaying a bird's-eye view on a display of a terminal device;
displaying, in the bird's-eye view, a plurality of photography point icons indicating photography points and a selection icon for selecting an arbitrary position in the bird's-eye view,
the selection icon being configured movably on the bird's-eye view, and
the plurality of photography point icons being associated with image information indicating an image photographed at a photography point;
detecting a movement completion position of the selection icon, and deciding one photography point icon based on the movement completion position and a position of each photography point icon; and
outputting, to the display, image information associated with the one photography point icon.
